(19) United States
(12) Patent Application Publication
(10) Pub. No.: US 2025/0315293 A1
(43) Pub. Date: Oct. 9, 2025

(54) Job Scheduler with Secure Migration of Objects Between Environments

(71) Applicant: Redwood Software, Inc., Frisco, TX (US)

(72) Inventors: Mehul Amin, Budd Lake, NJ (US); Christopher Michaels, Denville, NJ (US)

(73) Assignee: Redwood Software, Inc., Frisco, TX (US)

(21) Appl. No.: 18/628,416

(22) Filed: Apr. 5, 2024

(51) Int. Cl. G06F 9/48; G06F 21/60

(52) U.S. Cl. CPC G06F 9/4856; G06F 9/4881; G06F 21/602

(57) ABSTRACT

A workload automation (WLA) system and method operates a job scheduler to automate jobs, that each specify one or more tasks to be performed by corresponding software programs, within and across computer systems. The job scheduler enables secure transfer of a job that includes sensitive information from a first instance of the job scheduler to a second instance by decrypting each encrypted item of sensitive information for transfer to the second instance and encrypting each such item with a transfer key which is used by the second instance to decrypt the transferred sensitive items and to then re-encrypt such sensitive items with a different key for storage and usage by the second instance.

### FIELD OF THE DISCLOSURE

This disclosure relates generally to computerized information systems and more particularly to secure transfer of information in computing environments.

### BACKGROUND

WorkLoad Automation (WLA) systems are increasingly used to automate Information Technology (IT) tasks. A WLA system permits specification of a job that defines a sequence of tasks to be performed by one or more software application programs, which can include application programs and system software. The job may then be executed to automate the tasks specified by the job.

Increasingly, computer systems and software applications require credentials to control usage of such systems and applications and to control data manipulated and or stored by such systems and applications. Such credentials and other data referred to collectively as “sensitive data,” pose particular problems to WLA because of the need for various individuals required within development, test and production environments associated with any WLA job. Moreover, WLA jobs may be transferred within groups within an organization, further complicating the entry and management of credentials and/or increasing the risk of exposure of sensitive information. There is accordingly a need for improved methods and systems for managing sensitive data in WLA systems.

### SUMMARY

Disclosed herein are embodiments of methods and systems for securely transferring objects from a first environment implemented by a first instance of a job scheduler to a second environment implemented by a second instance of the job scheduler. In one embodiment, a computer-implemented method operates to transfer objects from a first environment implemented by a first instance of a job scheduler to a second environment implemented by a second instance of the job scheduler. In the method the first instance of the job scheduler is operated to generate one or more jobs where each job includes one or more tasks performed by one or more software programs, where a first of the software programs requires a corresponding credential to use its services. The first instance of the job scheduler encrypts, with a first encryption key, each credential to generate a corresponding encrypted credential for storage and subsequent use by the first instance of the job scheduler. The first instance of the job scheduler responds to a transfer environment command by retrieving each encrypted credential, decrypting each encrypted credential with the first encryption key to generate a corresponding decrypted credential, encrypting each decrypted credential with a transfer encryption key to generate a corresponding encrypted transfer credential, and causing transfer of a package to the second instance of the job scheduler. The package comprises a specification of one or more of the jobs and each encrypted transfer credential associated with the one or more jobs.

The specification may include a sequence of commands wherein each of the commands is associated with a software program.

The second instance of the job scheduler may be operated to accept the package from the first instance of the job scheduler, decrypt each encrypted transfer credential with the transfer encryption key to generate a corresponding received unencrypted credential, encrypt each received unencrypted credential with a second encryption key to generate a corresponding received encrypted credential, and store the selected package with each received encrypted credential to second data storage.

The credential information described above is merely one example of sensitive information and other types of sensitive information may be managed in the manner described above by the embodiments of the job schedulers disclosed herein.

In another embodiment, a computer system includes first data storage having stored therein, a plurality of packages where each package comprises one or more commands, where each command causes an associated software program to perform a task. The packages may include one or more encrypted data items. One or more processors are configured to access the first data storage. The one or more processors execute instructions that cause the one or more processors to execute a first instance of a job scheduler that generates the plurality of packages and that encrypts sensitive data with a first encryption key to generate the one or more encrypted data items. The first instance of the job scheduler responds to a transfer command that specifies transfer of a selected package of the plurality of packages by retrieving each encrypted data item associated with the selected package from the data storage, decrypting each encrypted data item associated with the selected package to generate a corresponding decrypted data item, encrypting each decrypted data item with a transfer encryption key to generate a corresponding transfer-encrypted data item, associating each transfer-encrypted data item with the selected package, and making the selected package available for transfer to a second instance of the job scheduler.

The one or more of the encrypted data items may comprise credential information employed by the first instance of the job scheduler to obtain access to a corresponding software program. The one or more of the encrypted data items may also comprise access keys to a software-controlled vault. The encrypted data items may also comprise a character string.

The computer system may also execute instructions that cause the one or more processors to execute a second instance of the job scheduler that accepts the selected package from the first instance of the job scheduler, decrypt each transfer-encrypted data item with the transfer encryption key to generate a corresponding received sensitive data item, encrypt received sensitive data item with a second encryption key to generate a corresponding encrypted sensitive data item, and store the selected package with each encrypted sensitive data item to second data storage.

Additional aspects related to the invention will be set forth in part in the description that follows, and in part will be apparent to those skilled in the art from the description or may be learned by practice of the invention. Aspects of the invention may be realized and attained by means of the elements and combinations of various elements and aspects particularly pointed out in the following detailed description and the appended claims.

It is to be understood that both the foregoing and the following descriptions arc exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive techniques. Elements designated with reference numbers ending in a suffix such as .1, .2, .3 are referred to collectively by employing the main reference number without the suffix. For example, 100 refers to items 100.1, 100.2, 100.3 generally and collectively.

FIG. 1 is a block diagram illustrating at a high-level an embodiment of secure transfer of packages between instances of a disclosed job scheduler.

FIG. 2 is a block diagram illustrating various operations performed by a disclosed job scheduler.

FIG. 3 is a block diagram illustrating contents of a job package generated by a disclosed job scheduler.

FIG. 4 is a flow diagram illustrating generation and editing of a job package by a disclosed job scheduler.

FIG. 5 is a flow diagram illustrating operations performed by a disclosed job scheduler to securely export a job package.

FIG. 6 is a flow diagram illustrating operations performed by a disclosed job scheduler to securely import a job package.

FIG. 7 is a block diagram of computer hardware that may be employed in certain embodiments of computer systems described herein.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of the present invention. The following detailed description is, therefore, not to be construed in a limited sense.

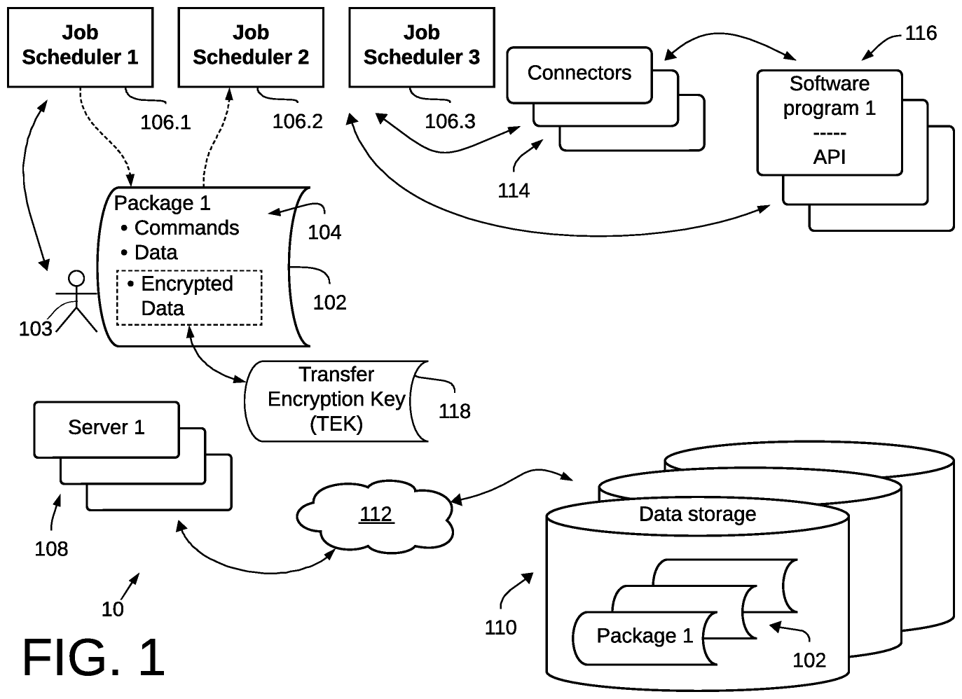

FIG. 1 is a block diagram of a system 10, illustrating at a high-level an embodiment of secure transfer of a package 102 that contains a definition of a job 104 between instances of a disclosed job scheduler 106. For case of explanation, three instances of job scheduler 106 are shown as 106.1 (job scheduler 1), 106.2 (job scheduler 2) and 106.3 (job scheduler 3). In FIG. 1, a plurality of servers 108 operate in conjunction with one or more data storage devices 110. The servers 108 are operatively coupled to the data storage devices 110 via a communication mechanism 112, which may take the form of direct connections or one or more different types of networked connections. One or more job schedulers 106 such as job scheduler 1, job scheduler 2, and job scheduler 3 execute on the one or more servers 108 to each provide a central automation hub for scheduling and monitoring so that various systems commonly used in an organization, such as customer relationship management (CRM), enterprise resource (ERP), business intelligence (BI), extraction transform load (ETL), work order management, project management, and consulting systems, work together seamlessly with minimal human intervention. The job schedulers 106 each provide a user interface to permit a user to build and orchestrate cross-functional workflows. The job schedulers 106 handle load balancing, scheduling, dependency checking, reporting and notifications. Each job scheduler 106 may be connected via connectors 114 to any server, application, or service to orchestrate workflows that run jobs 104 on endpoints across the system 10. For example, the connectors 114 provide prebuilt actions for commonly used operations such as managed file transfers to perform common: file operations, ETL tasks and Hadoop workloads, IT processes, BI, ERP and Business Process Management (BPM) processes across an organization. The connectors 114 also permit integration and scheduling of scripts into end-to-end, cross-platform workflows. By way of example a job 104, which may also be referred to as a workflow may comprise the following operations: wait for a file to be stored into a specified folder; move the file to another folder; read the file and enter its contents into a database; extract data from the database for BI reporting. Such an example comprises four operations.

In one embodiment, the job schedulers 106 connect to one or more software programs 116 to implement one or more workflows via a REST (REpresentational State Transfer) API. As will be appreciated by those skilled in the art, a REST interface is characterized by (i) unique identification of each resource involved in an interaction between a client and a server, (ii) uniform representation of a resource in a server response, (iii) sufficient resource representation to permit processing of a message and any additional actions that a client can perform on a resource, and (iv) use by a client of hyperlinks to drive all other resources and interactions. The software programs 116 can include system software such as an operating system or components thereof, application software, and software and services that may be remotely located (sometimes referred to as “cloud services and/or cloud applications”). Reference herein is occasionally made to systems and in the context of a job 104 accessing or employing services provided by a system, it is to be understood that such access or service is provided by a software program. The software programs 116 may execute on the one or more servers 118 or on separate servers that may be remotely located from the servers 118, which themselves may be located at various locations.

The job schedulers 106 are often used in a manner in which several job schedulers 106, each of which is an instance of a job scheduler 106, are provisioned to accommodate the need for isolation between environments. Common examples include, different stages, development, test, production in an automation development lifecycle or different divisions within an organization, where it may be desirable to copy a workflow between an instance of a job scheduler 106 in one department to an instance of a job scheduler 106 in a different department. Each job scheduler 106 includes tools that provide an administrator with the ability to move objects employed by one instance of a job scheduler 106 to another instance of a job scheduler 106.

Information Technology (IT) systems commonly employ credentials to control access to a system and to limit operations performed by a user of the system to ensure that only authorized individuals have access to certain data and certain operations that can be performed by the system. For example, a human resources system will typically limit access to certain users within a human resources department and any user that has access may only be able to perform certain functions. For example, certain authorized users will not be able to access salary information of certain individuals, and other authorized users will not be able to change salary information. In automating operations performed on a human resource system, a job scheduler 106 will require access to credential information for certain accounts, the users of which are permitted to perform certain functions authorized to be performed by that account.

In order to provide automation of tasks such as the ones described above, each job scheduler 106 instance must manage credential information and other potentially sensitive data which are stored within object managed by the instance of the job scheduler 106. In order to transfer jobs between instances, disclosed job schedulers 106 are able to handle the differing security requirements inherent to multi-environment ecosystems. As shown generally in FIG. 1, job scheduler 1 generates for a job 104, a package 102 (package 1) that includes commands to perform the tasks of the job 104. The package 102 may also include certain data required for the job 104. This may include data to be provided to an application, such as for instance, in a human resources example, data to be entered into an employee record. The package 102 may also include certain sensitive data that is stored in encrypted form.

The sensitive data may include personally identifiable information (PII), which is data that can be traced back to an individual and that, if disclosed, could result in harm to that person. Such information can include biometric data, medical information, personally identifiable financial information (PIFI) and unique identifiers such as passport or Social Security numbers. The sensitive data may also include sensitive business information which may include anything that poses a risk to a company in question if discovered by a competitor or the general public. Such information includes trade secrets, acquisition plans, financial data and supplier and customer information, among other possibilities. The sensitive data may also include classified information which is information that pertains to a government body and is restricted according to level of sensitivity (for example, restricted, confidential, secret and top secret).

In the development of a job 104 in a WorkLoad Automation (WLA) system such as that shown in FIG. 1, an IT administrator will create an account, sometimes referred to as a service account for an application or system, to be used in performing the tasks specified by the particular application or system in performance of the job 104. A developer of the job 104 may generate the necessary credentials, such as a username and password. When the job 104 has been completed by the developer it is typically passed to quality assurance for testing. For security purposes, it is often preferable that the quality assurance team not be exposed to, for example, the password for the applications and systems specified in the job 104. A similar issue exists upon transferring the job 104 from the quality assurance environment to a production environment. The production team can cause the job 104 to be executed but preferably should not be privy to any credentials required to access the applications and systems specified by job 104. Similar issues can occur when copying a job 104 from one group or division in a company to another group or division. While it is possible for an IT administrator to change the credentials upon completion of the development and testing phases, this can be a cumbersome and error prone task as the number of jobs 104 in an environment increase and as any given job may need to be modified, which again requires movement from testing to quality assurance to development. The regular involvement required by IT administrators in such a process can slow development of jobs 104 and can expose sensitive data which can lead to loss of PII, sensitive business information and/or classified information.

The embodiments disclosed herein provide a novel solution to the foregoing operational and security issues. In FIG. 1, sensitive data is shown as being encrypted by job scheduler 1. To transfer package 1 from job scheduler 1 to job scheduler 2 (i.e. instance 1 to instance 2), disclosed embodiments employ a Transfer Encryption Key (TEK) 118 to securely perform the transfer. This ensures that sensitive data cannot be accessed while in transit from one instance to another while enabling simplified transfer that does not require either transfer of credentials from individuals involved in one development phase to another development phase or from one department to another.

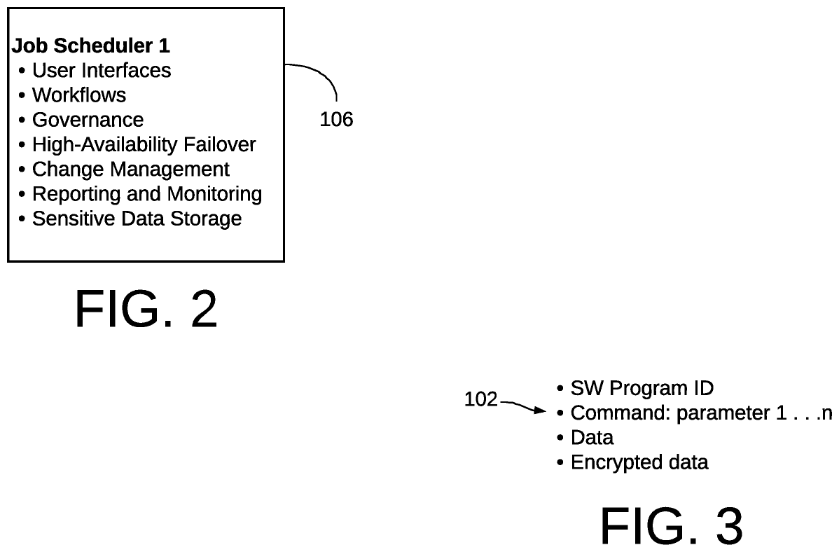

FIG. 2 shows various capabilities of an embodiment of a job scheduler 106, which includes providing user interfaces for specification of a job, pre-built workflows, governance to . . . , high-availability failover, change management and reporting, monitoring and storage of sensitive data.

FIG. 3 is a block diagram illustrating contents of a job package 102 generated by a disclosed job scheduler 106. In general, job package 102 includes commands and data in unencrypted or encrypted form. A command is performed by a software program 116 that is identified in conjunction with a command in the package 102 by an ID. Commands may require various parameters and these parameters are also included in conjunction with commands stored in a job package 102. In one embodiment a package 102 is stored as structured data in a relational database. In another embodiment a package 102 is stored in a file having a known structure.

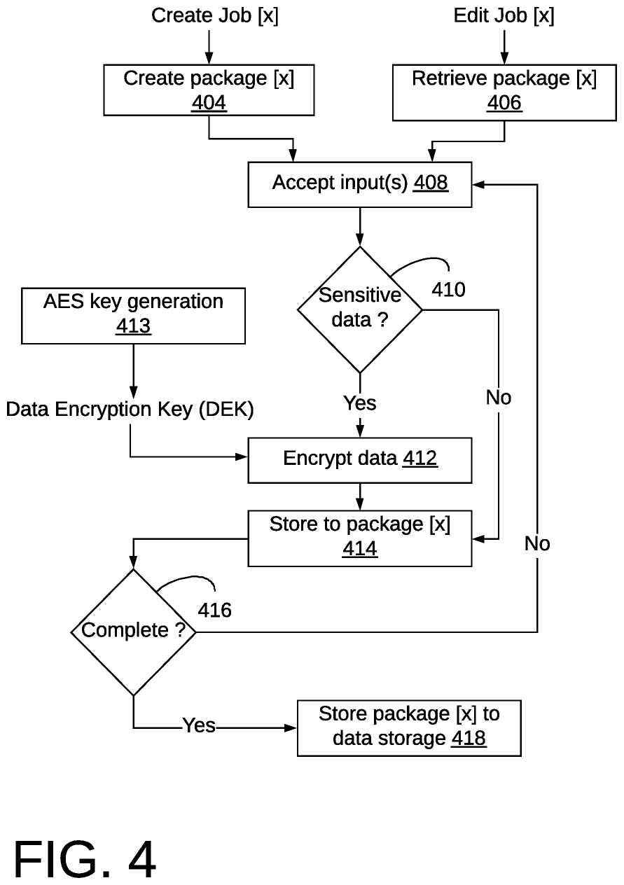

FIG. 4 is a flow diagram illustrating generation and editing of a job package 102 by a disclosed job scheduler 106. A job scheduler 106 may receive a create job [x] command where, x specifies a job name to create 404 a new job. A job scheduler 106 may also receive an edit job [x] command where, to edit 406 an existing job. The job scheduler 106 accepts inputs 408 to specify the job x. Sensitive data is specified as such upon entry and any sensitive data detected 410 is encrypted 412. In one embodiment, such encryption is performed with a Data Encryption Key (DEK) generated 413 in accordance with the Advanced Encryption Standard (AES). Data, whether encrypted or unencrypted is stored 414 to package [x]. Upon detection of completion 416, package [x] is stored 418 to data storage 110. The DEK is typically automatically generated during configuration of the job scheduler 106 and is securely stored to a data storage such as a registry maintained by the job scheduler 106. The DEK may also be provided by an administrator in instances where an existing key is desired to be used. Both keys are auto generated or created during the configuration process of the job scheduler after its installed. It gets stored securely on the job scheduler system.

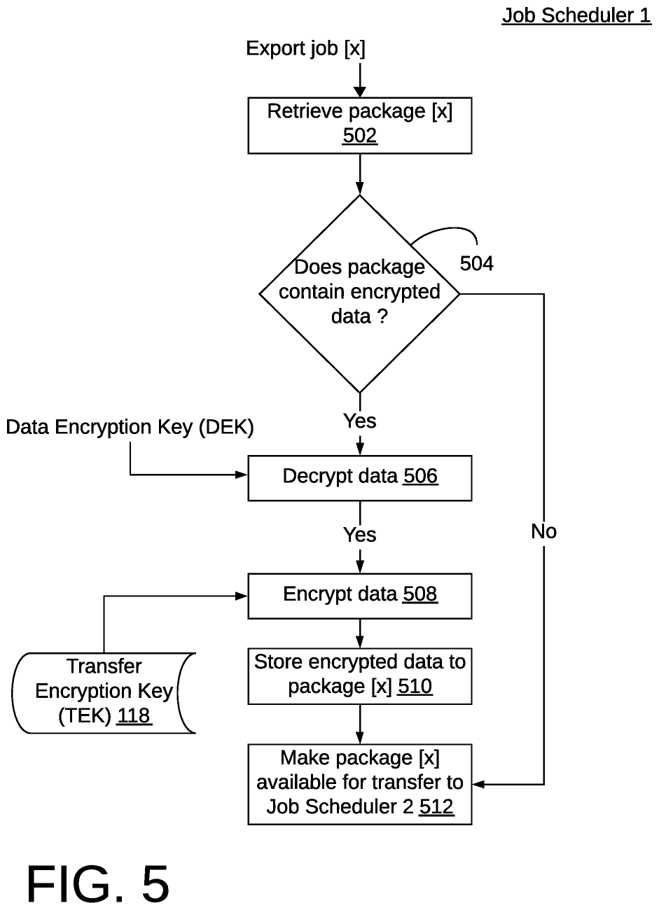

FIG. 5 is a flow diagram illustrating operations performed by a disclosed job scheduler 106 to securely export a job package 102. In FIG. 5, package [x] is exported from instance 1 of job scheduler 106 (job scheduler 1) to instance 2 of job scheduler 106 (job scheduler 2). Package [x] is retrieved 502 and is checked 504 to determine if it contains any encrypted data. If so, the encrypted data is decrypted 506 with the DEK. The newly unencrypted data is then encrypted 508 with a TEK 118. The TEK 118 is typically automatically generated during configuration of the job scheduler 106 and is securely stored to a data storage such as a registry maintained by the job scheduler 106. The TEK 118 may also be provided by an administrator in instances where an existing key is desired to be used. This latter example may occur for example where multiple instances of a job scheduler 106 are created. In such a case a TEK 118 may be created for a first instance that is created and then provided to subsequent instances. The encrypted data is stored 510 to package [x] and made available 512 to the transferee instance of the job scheduler 106 (job scheduler 2). It should be noted that the TEK 118 is different than the DEK and the TEK 118 is used to specifically store sensitive data in transit between different instances of the job scheduler 106. In one embodiment, the encryption with the TEK 118 is also performed in accordance with the Advanced Encryption Standard (AES). In one embodiment, the job scheduler 106 loads all data into memory and removes DEK encryption from fields containing sensitive data. Before the data is written to storage it is encrypted using the TEK 118. The DEK and TEK 118 are automatically generated in accordance with AES during configuration of job scheduler 106 upon its installation. The DEK and TEK 118 are securely stored by the job scheduler 106. The export to and import from operations can be performed independently of one another or may be linked such as the import from operation is performed automatically upon completion of the export to operation.

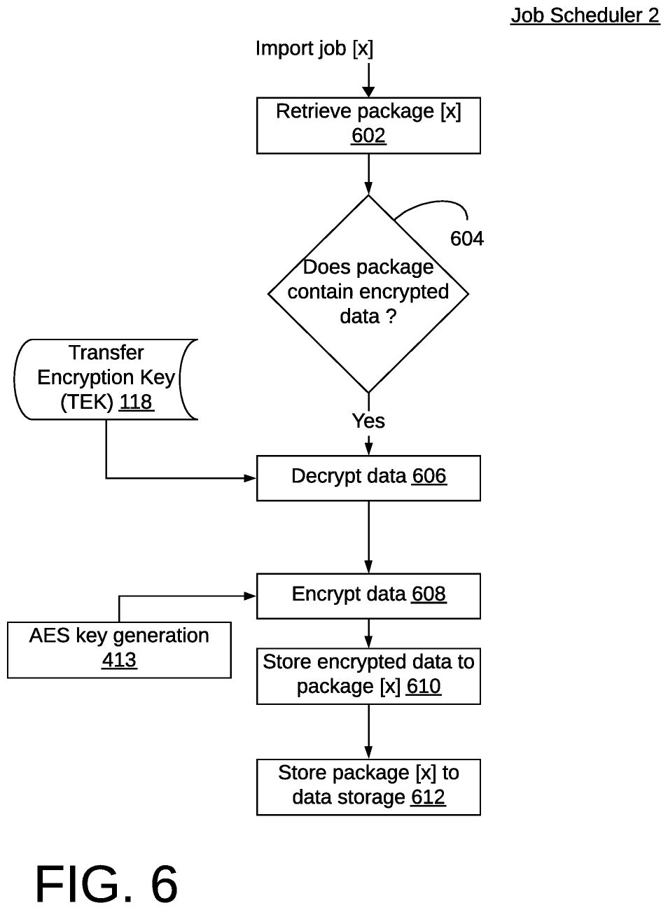

FIG. 6 is a flow diagram illustrating operations performed by a disclosed job scheduler 106 to securely import a job package 102. In FIG. 6, package [x] is imported from instance 1 of job scheduler 106 (job scheduler 1) to instance 2 of job scheduler 106 (job scheduler 2). Package x is retrieved 602 and checked 604 to determine if it contains encrypted data. If so, any encrypted data is decrypted 606 using the TEK 118 and is then encrypted 608 with a new DEK. Upon completion of encryption, the encrypted data is stored 610 to package [x] and package [x] is stored 612 to data storage 110. The job scheduler 106 performs the reciprocate of the export process to decipher the incoming data and save it to data storage 110 using the destination job schedulers 106 own DEK.

In the embodiments described above, the DEK is usable only by an administrator who will have secure access to job scheduler 106 which permits the administrator to create a job scheduler 106 and to configure it. Generation of and changing of a DEK requires administrator level access by the account used to configure the job scheduler 106. The TEK 118, which like the DEK is generated automatically upon configuration of a job scheduler 106, is available for use by an operator of a job scheduler 106. This permits an operator, of which there may be many, to cause a transfer of a job scheduler 106 from one environment to another, thereby avoiding the need for involvement by an administrator. The TEK 118, which is generated upon configuration of a job scheduler 106 is in existence and may be used by an operator to cause transfer of a job scheduler 106 to another environment while sensitive data is protected by way of the TEK 118 during the transfer.

The embodiments herein can be implemented in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may also include a device or product having content stored thereon at time of sale or delivery. Thus, delivering a device with stored content, or offering content for download over a communication medium may be understood as providing an article of manufacture with such content described herein.

The terms “computer system” and “computing device” are used interchangeably herein. Unless the context clearly indicates otherwise, neither term implies any limitation on a type of computing system or computing device. In general, a computing system or computing device can be local or distributed and can include any combination of special-purpose hardware and/or general-purpose hardware with software implementing the functionality described herein.

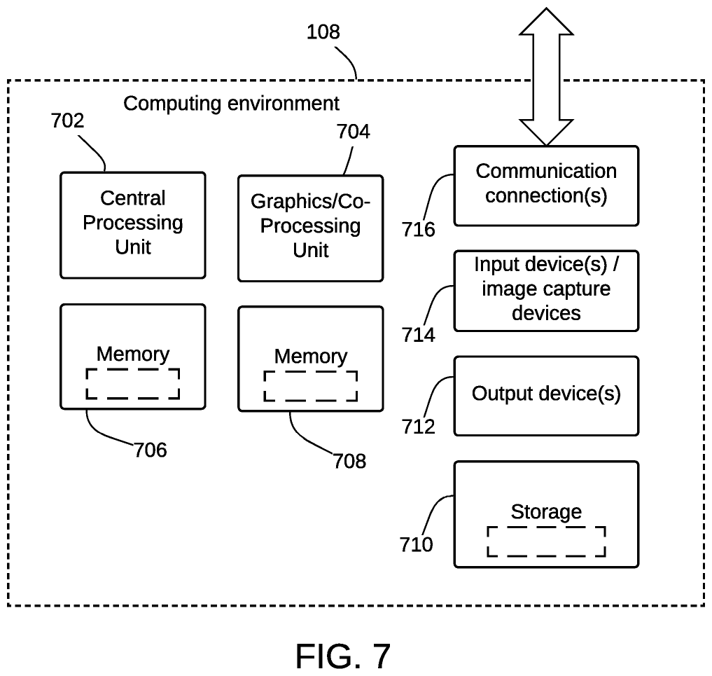

FIG. 7 illustrates a block diagram of hardware that may be employed in an implementation of each server 108 as disclosed herein, in which the described innovations may be implemented in order to improve the processing speed and efficiency with which the hardware operates to perform the functions disclosed herein. With reference to FIG. 7 the server 108 includes one or more processing units 702, 704 and memory 706, 708. The processing units 702, 704 execute computer-executable instructions. A processing unit can be a general-purpose central processing unit (CPU), processor in an application-specific integrated circuit (ASIC) or any other type of processor. The tangible memory 706, 708 may be volatile memory (e.g., registers, cache, RAM), non-volatile memory (e.g., ROM, EEPROM, flash memory, etc.), or some combination of the two, accessible by the processing unit(s). The hardware components in FIG. 7 may be standard hardware components, or alternatively, some embodiments may employ specialized hardware components to further increase the operating efficiency and speed with which the server 108 operates. The various components of server 108 may be rearranged in various embodiments, and some embodiments may not require nor include all of the above components, while other embodiments may include additional components, such as specialized processors and additional memory.

Server 108 may have additional features such as for example, storage 710, one or more input devices 714, one or more output devices 712, and one or more communication connections 716. An interconnection mechanism (not shown) such as a bus, controller, or network interconnects the components of the server 108. Typically, operating system software (not shown) provides an operating system for other software executing in the server 108, and coordinates activities of the components of the server 108.

The tangible storage 710 may be removable or non-removable, and includes flash memory, magnetic disks, magnetic tapes or cassettes, CD-ROMs, DVDs, nonvolatile random-access memory, or any other medium that can be used to store information in a non-transitory way and that can be accessed within the server 108. The storage 710 stores instructions for the software implementing one or more innovations described herein.

The input device(s) 714 may be a touch input device such as a keyboard, mouse, pen, or trackball, a voice input device, a scanning device, or another device that provides input to the server 108. For video encoding, the input device(s) 714 may be a camera, video card, TV tuner card, or similar device that accepts video input in analog or digital form, or a CD-ROM or CD-RW that reads video samples into the server 108. The output device(s) 712 may be a monitor, printer, speaker, CD-writer, or another device that provides output from the server 108.

The communication connection(s) 716 enable communication over a communication medium to another computing entity (such as between servers 108). The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

It should be understood that functions/operations shown in this disclosure are provided for purposes of explanation of operations of certain embodiments. The implementation of the functions/operations performed by any particular module may be distributed across one or more systems and computer programs and are not necessarily contained within a particular computer program and/or computer system.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A computer system comprising:
first data storage having stored therein, a plurality of packages wherein each package of the plurality of packages comprises one or more commands, wherein each command of the plurality of commands causes an associated software program to perform a task, wherein or more of the packages includes one or more encrypted data items;
one or more processors that are configured to access the first data storage and that execute instructions that cause the one or more processors to execute a first instance of a job scheduler that,
generates the plurality of packages and that encrypts sensitive data with a first encryption key to generate the one or more encrypted data items;
responds to a transfer command that specifies transfer of a selected package of the plurality of packages by
retrieving each encrypted data item associated with the selected package from the data storage,
decrypting each encrypted data item associated with the selected package to generate a corresponding decrypted data item;
encrypting each decrypted data item with a transfer encryption key to generate a corresponding transfer-encrypted data item;
associating each transfer-encrypted data item with the selected package; and
making the selected package available for transfer to a second instance of the job scheduler.

2. The computer system of claim 1 wherein the one or more processors executes the first instance of the job scheduler to:
make the transfer encryption key available to the second instance of the job scheduler.

3. The computer system of claim 1 wherein one or more of the encrypted data items comprises credential information employed by the first instance of the job scheduler to obtain access to a corresponding software program.

4. The computer system of claim 1 wherein one or more of the encrypted data items comprises access keys to a software-controlled vault.

5. The computer system of claim 1 wherein one or more of the encrypted data items comprises a character string.

6. The computer system of claim 1 wherein the one or more processors execute instructions that cause the one or more processors to execute a second instance of the job scheduler that,
accepts the selected package from the first instance of the job scheduler;
decrypts each transfer-encrypted data item with the transfer encryption key to generate a corresponding received sensitive data item;
encrypts received sensitive data item with a second encryption key to generate a corresponding encrypted sensitive data item; and
stores the selected package with each encrypted sensitive data item to second data storage.

7. A computer-implemented method for transferring objects from a first environment implemented by a first instance of a job scheduler to a second environment implemented by a second instance of the job scheduler, the method comprising, operating the first instance of the job scheduler to:
generate one or more jobs where each job of the one or more jobs includes one or more tasks performed by one or more software programs, wherein a first software program requires a corresponding credential to use services provided by the first software program;
encrypt, with a first encryption key, each credential to generate a corresponding encrypted credential for storage and subsequent use by the first instance of the job scheduler;
respond to a transfer environment command by,
retrieving each encrypted credential;
decrypting each encrypted credential with the first encryption key to generate a corresponding decrypted credential;
encrypting each decrypted credential with a transfer encryption key to generate a corresponding encrypted transfer credential; and
causing transfer of a package to the second instance of the job scheduler, wherein the package comprises a specification of one or more of the jobs and each encrypted transfer credential associated with the one or more jobs.

8. The computer-implemented method of claim 7 wherein the specification comprises a sequence of commands wherein each of the commands is associated with a software program.

9. The computer-implemented method of claim 7 wherein operating the first instance of the job scheduler further comprises:
making the transfer encryption key available to the second instance of the job scheduler.

10. The computer-implemented method of claim 7 further comprising, operating a second instance of the job scheduler that,
accepts the package from the first instance of the job scheduler;
decrypts each encrypted transfer credential with the transfer encryption key to generate a corresponding received unencrypted credential;
encrypts each received unencrypted credential with a second encryption key to generate a corresponding received encrypted credential; and
stores the selected package with each received encrypted credential to second data storage.

11. A computer program product stored on a non-transitory computer readable storage medium and including instructions for causing a computer system to execute a method for transferring objects from a first environment implemented by a first instance of a job scheduler to a second environment implemented by a second instance of the job scheduler, the method comprising, operating the first instance of the job scheduler to:
generate one or more jobs where each job of the one or more jobs includes one or more tasks performed by one or more software programs, wherein a first software program requires a corresponding credential to use services provided by the first software program;
encrypt, with a first encryption key, each credential to generate a corresponding encrypted credential for storage and subsequent use by the first instance of the job scheduler;
respond to a transfer environment command by,
retrieving each encrypted credential;
decrypting each encrypted credential with the first encryption key to generate a corresponding decrypted credential;
encrypting each decrypted credential with a transfer encryption key to generate a corresponding encrypted transfer credential; and
causing transfer of a package to the second instance of the job scheduler, wherein the package comprises a specification of one or more of the jobs and each encrypted transfer credential associated with the one or more jobs.

12. The computer program product of claim 11 wherein the specification comprises a sequence of commands wherein each of the commands is associated with a software program.

13. The computer program product of claim 11 wherein the method further comprises operating the first instance of the job scheduler to:
make the transfer encryption key available to the second instance of the job scheduler.

14. The computer program product of claim 11 wherein one or more of the encrypted data items comprises credential information employed by the first instance of the job scheduler to obtain access to a corresponding software program.

15. The computer program product of claim 11 wherein one or more of the encrypted data items comprises access keys to a software-controlled vault.

16. The computer program product of claim 11 wherein one or more of the encrypted data items comprises a character string.

17. The computer program product of claim 11 wherein the method further comprises operating a second instance of the job scheduler to:
accept the selected package from the first instance of the job scheduler;
decrypt each transfer-encrypted data item with the transfer encryption key to generate a corresponding received sensitive data item;
encrypt received sensitive data item with a second encryption key to generate a corresponding encrypted sensitive data item; and
store the selected package with each encrypted sensitive data item to second data storage.
